(19) United States
(12) Patent Application Publication
(10) Pub. No.: US 2026/0251254 A1
(43) Pub. Date: Aug. 27, 2026

(54) METHOD OF COUPLING OR REPAIRING PIPES

(71) Applicant: Pinweld Limited, Calne Wiltshire (GB)

(72) Inventor: Keven Chappell, Calne Wiltshire (GB)

(73) Assignee: Pinweld Limited, Calne Wiltshire (GB)

(21) Appl. No.: 19/160,148

(22) PCT Filed: Feb. 20, 2024
(86) PCT No.: PCT/GB2024/050473

§ 371 Date: Aug. 27, 2025

(30) Foreign Application Priority Data
Feb. 28, 2023 (GB) 2302946.5

(51) Int. Cl. F16L 47/02; F16L 55/165

(52) U.S. Cl. CPC F16L 47/02; F16L 55/1652

(57) ABSTRACT

The present invention relates to a method of coupling pipes to one another, and is particularly beneficial for coupling polymeric pipes such as PVC pipes. Disclosed is a method of welding a first pipe to a pipe fitting comprising the steps of providing a pipe having a pipe engagement portion;

providing a pipe fitting having a pipe fitting engagement portion for engagement with the pipe engagement portion; engaging the pipe and pipe fitting engagement portions to provide an overlap region between the pipe and pipe fitting engagement portions; and providing a welding apparatus comprising a heating element carried by a body, and welding at least a portion of the pipe and pipe fitting engagement portions by reciprocating the heating element relative to the body between a retracted and extended configuration in the overlap region, such that as the heating element moves from a retracted to the extended configuration the heating element melts and penetrates both the pipe engagement portion and pipe fitting engagement portion forming a weld.

### METHOD OF COUPLING PIPES

The present invention relates to a method of coupling pipes to one another, particularly beneficial for coupling polymeric pipes such as PVC pipes.

There are many different techniques for welding pipes with or without a coupling. Butt welding is a widely used technique where the ends of two respective pipes are carefully aligned, heated to cause the material to flow and forced together under specific parameters of time and pressure depending on the material to be welded. A weld is formed at in the area where the two pipe sections abut.

A further technique is electrofusion welding where a coupling implanted with metal coils is placed around the respective ends of the pipe. This technique is widely used to weld plastic pipes made from polyethylene (PE) and polypropylene (PP). The pipe ends are firstly cleaned and the outer surface of the pipes scraped. They are then positioned into respective ends of the coupling and clamped into position. A current is passed through the coils in the coupling resulting in resistive heating in the coupling and pipe thereby causing some melting of both the pipe and coupling. Upon solidifying, a weld is formed.

Whilst both butt welding and electrofusion welding techniques can successfully weld pipes, there is a high failure rate. This is typically because of variations in the welding parameters caused either by failure to use the precise settings for the specific pipe material and size to be welded, or due to environmental variations such as air temperature having an effect on the optimal parameters. Whilst environmental conditions can be carefully controlled inside a building, it is usually necessary to join pipes at the location in which they are used, where there can be significant changes in weather conditions. This leads to a high pipe failure rate, and as the pipes are often inaccessible repair is difficult and expensive.

Aspects of the present invention address the above-mentioned problems or at least provide a useful alternative.

According to a first aspect of the present invention there is a method of welding a first pipe to a pipe fitting comprising the steps of:
providing a pipe having a pipe engagement portion;
providing a pipe fitting having a pipe fitting engagement portion for engagement with the pipe engagement portion;
engaging the pipe and pipe fitting engagement portions to provide an overlap region between the pipe and pipe fitting engagement portions;
providing a welding apparatus comprising a heating element carried by a body, and welding at least a portion of the pipe and pipe fitting engagement portions by reciprocating the heating element relative to the body between a retracted and extended configuration in the overlap region, such that as the heating element moves from a retracted to the extended configuration the heating element melts and penetrates both the pipe engagement portion and pipe fitting engagement portion forming a weld.

The first engagement portion has a longitudinal axis, and the second engagement portion has a longitudinal axis, where engagement is achieved by movement of one or both of the first and/or second engagement portions in the longitudinal axis. The region of overlap is a longitudinal overlap region. The method preferably involves sliding the pipe and pipe fitting engagement portions together. It will be understood that the pipe engagement portion comprises a portion of the pipe that engages with the pipe coupling.

The pipe fitting may comprise a coupling, cap or plug, elbow, bend or other known pipe fitting. The pipe fitting is particularly beneficial as a coupling for coupling pipes to one another.

The pipe preferably comprises a first pipe having a first pipe engagement portion and there is further provided a second pipe having a second pipe engagement portion, where the pipe fitting comprises first and second pipe fitting engagement portions, and the method preferably further comprises the step of engaging the second pipe engagement portion and second pipe engagement portion to provide a second overlap region, and welding at least a portion of the second pipe engagement portion and second pipe fitting engagement portion by reciprocating the heating element relative to the body between a retracted and extended configuration in the second overlap region, such that as the heating element moves from a retracted to the extended configuration the heating element melts and penetrates both the second pipe engagement portion and the second pipe fitting engagement portion forming a second weld.

The method is particularly beneficial for welding polymeric pipes and polymeric pipe fittings. The method is particularly beneficial for welding thermoplastic pipes and thermoplastic pipe fittings.

The pipe and pipe fitting engagement portions comprise a longitudinal axis, where the heating element beneficially reciprocates in an axis substantially perpendicular to the longitudinal axis of the pipe and pipe fitting engagement portions.

The heating element beneficially reciprocates relative to the body as the body is moved along the overlap region to form an elongate weld. The body is preferably moved circumferentially around the overlap region such that the elongate weld extends circumferentially around the overlap region. The weld is preferably an annular weld. Although a spot weld may in some circumstances be sufficient for welding the first pipe to the pipe fitting, it is beneficial that a complete annular weld is performed. This means that a potential leak pathway between the first and second engagement portions is blocked with an annular weld effected by repetitive reciprocation of the heating element as the body moves circumferentially.

The pipe fitting engagement portion preferably defines a socket, and the pipe engagement portion is located into the socket. It will be appreciated in the alternative that in a second configuration the pipe engagement portion defines a socket, and the pipe fitting engagement portion is located into the socket. This second configuration is particularly beneficial when the pipe fitting is a coupling and a long length of pipe is required without any radially extending obstruction. An example of such an application is subsea, where it is necessary to insert a polymeric pipe into an existing metal pipe due to approaching end of usable life for the subsea application. Utilising a coupling that is received into first and second pipes means the external diameter of the coupling is no greater than the external diameter of the first and second pipes.

The pipe has a pipe wall having a pipe wall thickness and the pipe fitting has a pipe fitting wall having a pipe fitting wall thickness, and where the heating element melts and penetrates through the entirety of the thickness of one of the pipe wall or pipe fitting wall. The heating element beneficially only partially melts and penetrates through the thickness of the other of the pipe wall or pipe fitting wall. This provides for a strong and effective weld, whilst not requiring complete penetration of both thicknesses removing alignment issues and also ensuring one of the surfaces is not disrupted. This may be particularly useful for a pipe fitting that receives the pipe as the internal wall of the pipe will have any sign of welding.

It will be appreciated that the first (and optional second) pipe has a longitudinal length defining a bore therethrough. The pipe fitting also has a longitudinal length, further preferably defining a bore therethrough.

The welding apparatus is beneficially guided around the overlap region by one or more annular guide formations in the pipe and/or pipe fitting. The or each annular guide formation may comprise an annular groove. The welding apparatus is arranged to seat into the groove thereby ensuring accuracy of location of the weld in the overlap region.

One or more annular seals are beneficially positioned intermediate the first and second engagement portions. At least one annular seal is preferably disposed at a first distance from a distal end of the pipe, the seal is performed at a second distance from the distal end of the pipe, where the first distance is less than the second distance. This provides a significant benefit in that as the pipe and pipe fitting are engaged, at least one annular seal acts to clean the overlap region where the weld is completed. Furthermore, the seal limits the ability for the external environment to have a negative impact on the quality of the weld by sealing the weld from the environment.

A second problem exists in that it is difficult to repair a pipe once it has been commissioned. In many cases pipes are in harsh and inaccessible environments such as underground locations. Once a leak has been detected, it is then common for the pipe to be exposed by excavating around the area of the leak, following which a repair can be made. This is clearly time consuming, complex and leads to inconvenience for users of the environment surrounding the hole that has been excavated.

Aspects of the invention below address the above-mentioned problems or at least provide a useful alternative.

According to a second aspect of the present invention there is a method of repairing a pipe, the method comprising the steps of:
deploying a weldable repair insert into a repair zone in the internal conduit of a pipe to provide an overlap region between the insert and the pipe;
providing a welding apparatus comprising a heating element carried by a body and welding the insert and the pipe in the overlap region by reciprocating the heating element relative to the body between a retracted and extended configuration, such that as the heating element moves from a retracted to the extended configuration the heating element melts and penetrates both the weldable repair insert and the pipe forming a weld.

The second aspect of the present invention enables simple and effective repair, particularly but not exclusively, of polymeric pipes without the need for complex and expensive excavation. The weldable repair insert and pipe preferably comprise polymeric materials, preferably thermoplastic materials.

The heating element beneficially reciprocates relative to the body as the body is moved along the overlap region to form an elongate weld. The body is preferably moved circumferentially around the overlap region such that the elongate weld extends circumferentially around the overlap region. The weld is preferably an annular weld. Although a spot weld may in some circumstances be sufficient for welding the first pipe to the pipe fitting, it is beneficial that a complete annular weld is performed. This means that a potential leak pathway either between a pipe and a pipe fitting or in a wall of a pipe the first and second engagement portions, however this potential leak path is blocked with an annular weld.

The pipe has a pipe wall having a pipe wall thickness and the weldable repair insert has an insert wall thickness, and where the heating element melts and penetrates through the entirety of the thickness of one of the pipe wall or insert wall thickness. The heating element beneficially only partially melts and penetrates through the thickness of the other of the pipe wall or insert wall.

The weldable repair insert may comprise a whole or partial ring. The whole or partial ring comprises a whole or partial tubular portion. The method preferably comprises the step of radially compressing the ring and locating into the internal conduit at the repair zone, and where the radial compression is released in the repair zone such that the ring expands to be held in the weld zone by a friction fit between the ring and the pipe.

The welding apparatus may be positioned external of the pipe. The welding apparatus may therefore perform the weld from outside the pipe in some applications. Alternatively, the welding apparatus may be positioned inside the pipe, and therefore perform the weld from inside the bore. The welding apparatus is preferably carried to the overlap region by a remotely operable carrier vehicle. This means that the welding apparatus can be deployed into regions inaccessible to a person. The welding apparatus is therefore beneficially operable from a remote location. The welding apparatus may therefore be operated over a wireless network.

The weldable repair insert may comprise a patch. A patch may be particularly useful for example for covering a port in the pipe. Repair in the context of the second aspect of the present invention includes modifying the pipe.

The weld may be a spot weld or annular weld.

One or more seals may be positioned on an outer surface of the ring, where the seals seat between the outer surface of the ring and the inner surface of the pipe defining the conduit.

It will be appreciated that in some embodiments the heating element of the welding apparatus beneficially reciprocates relative to the body as the body is moved along the overlap region to form an elongate weld.

According to both aspects of the present invention the welding apparatus may operate in the same manner and have the same configuration. The heating element of the welding apparatus supplies heat to the pipe, pipe fitting and/or insert. The overlap region beneficially comprises a weld zone.

The body beneficially further comprises a trailing contact surface trailing the heating element along the weld zone arranged to constrain molten polymeric material in the weld zone, where the heating element is also arranged to reciprocate relative to the trailing contact surface. It will be appreciated that no filler is required according to the present invention, meaning the weld is formed by melting of existing material in the region of overlap.

In both embodiments the method preferably operates in the sequence of:
extending the heating element to the extended configuration where the heating element melts and penetrates the melts and penetrates both the pipe engagement portion and pipe fitting engagement portion (or the weldable repair insert and pipe in the second aspect) forming a weld;
retracting the heating element to the retracted configuration;
causing relative movement of the pipe and welding apparatus along the overlap region;
and subsequently repeating the sequence along the overlap region.

The welding method according to the present invention may be utilised to weld numerous polymeric materials to include a non-exhaustive list of polypropylene, polyethylene, ABS and polycarbonate, PVC and polyamide. Further blends of these materials may also be welded. This avoids the complex requirement of matching filler material with the respective material to be welded which is particularly difficult with blended materials.

Aspects of the present invention will now be described by way of illustration only with reference to the accompanying Figures where:

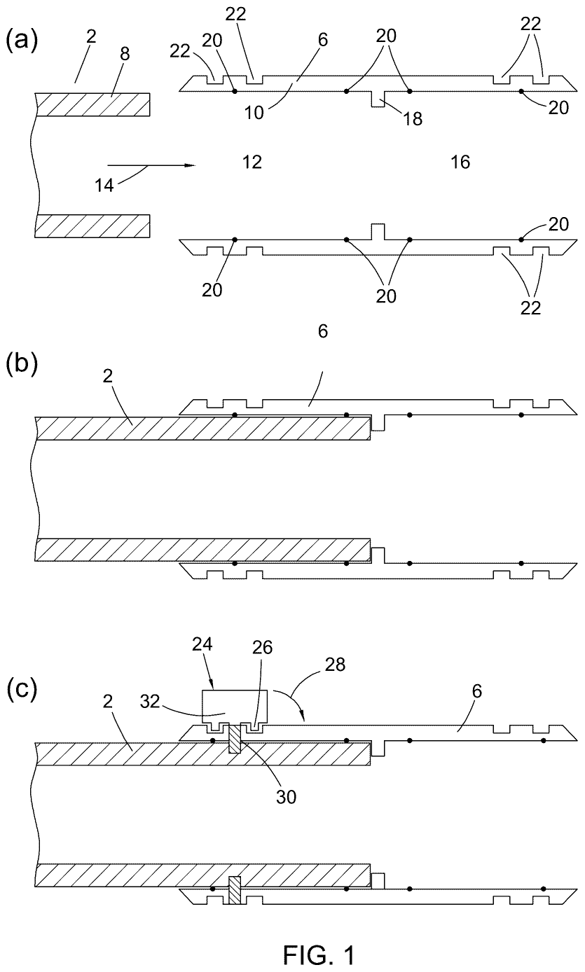

FIG. 1a-d is a schematic cross-sectional representation of the steps of connecting first and second pipes via a pipe fitting according to an illustrative embodiment of the present invention.

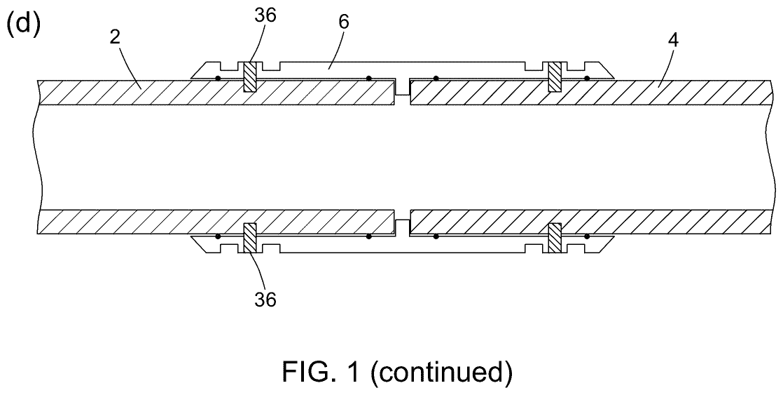

FIGS. 2a-b are schematic cross-sectional representations of first and second pipes welded together via a pipe fitting according to an illustrative embodiment of the present invention.

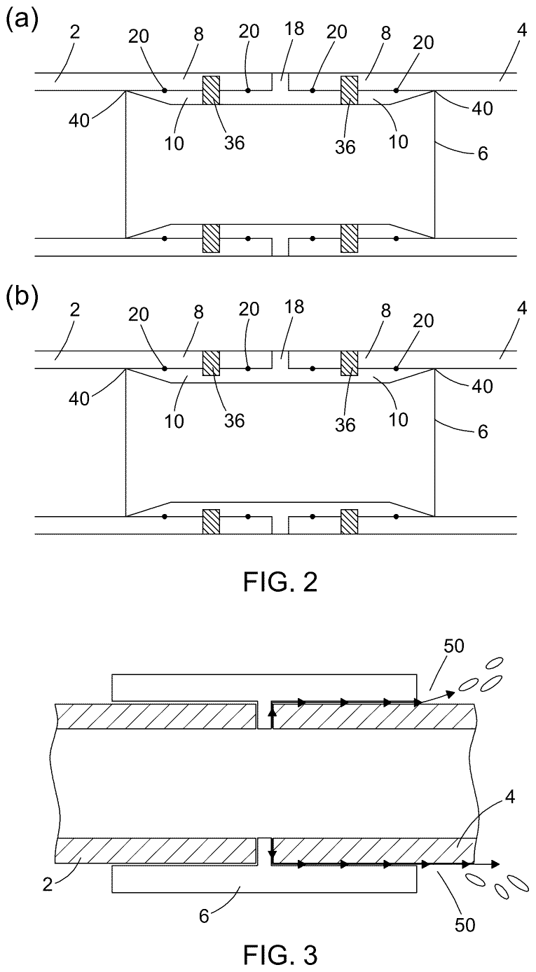

FIG. 3 is a schematic cross-sectional representation of an existing joint showing a typical leak pathway.

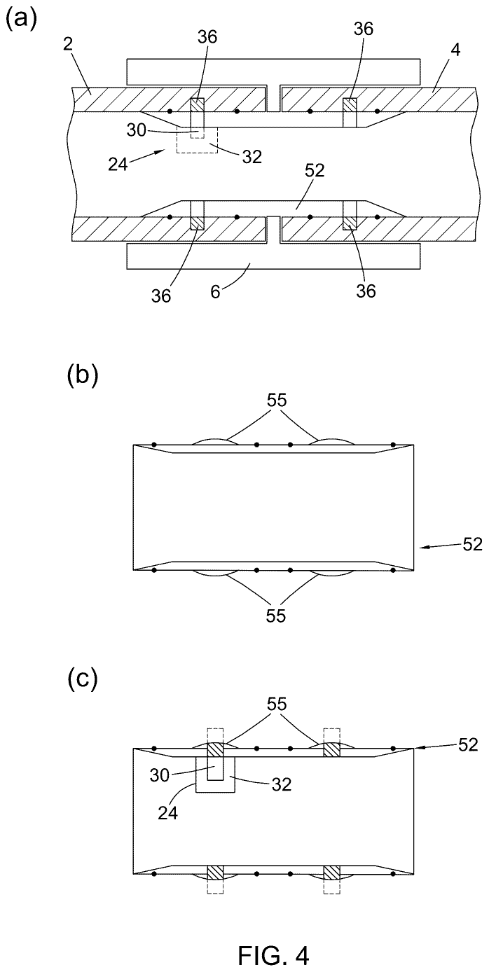

FIG. 4a is a schematic cross-sectional representation of an illustrative embodiment of a second aspect of the present invention, and FIG. 4b is a schematic representation of a weldable insert for use in the method according to a second aspect. FIG. 4c is a schematic cross sectional representation of a weldable insert as shown in FIG. 4b in a welded configuration with the welding apparatus still positioned in the internal bore of the weldable insert.

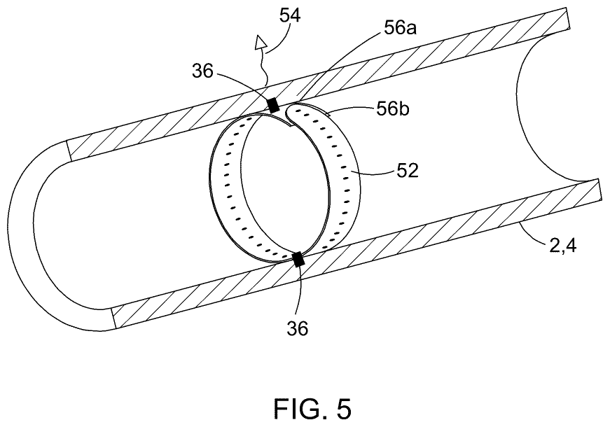

FIG. 5 is a schematic perspective cross sectional representation of a method of repairing a pipe according to an illustrative embodiment of the present invention.

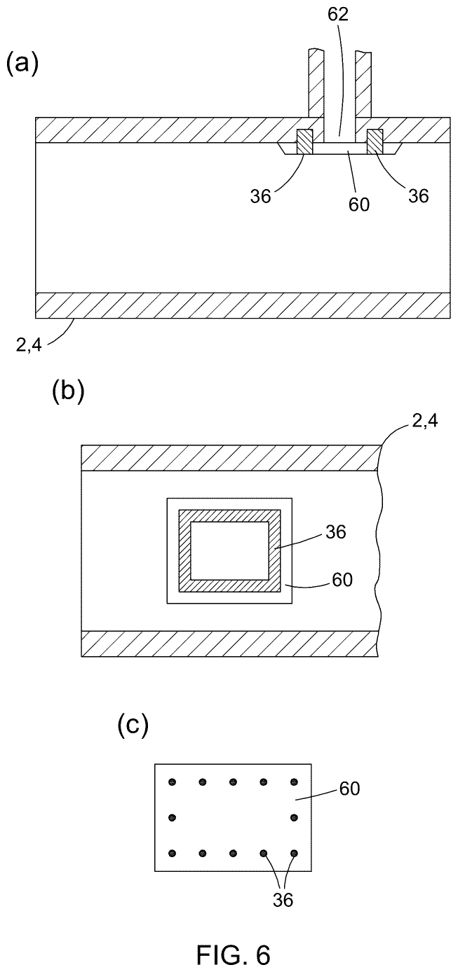

FIG. 6a is a schematic perspective cross sectional representation of a method of repairing a pipe according to an illustrative embodiment of the present invention. FIG. 6b is a schematic illustration of a method of repairing a pipe using a patch according to an illustrative embodiment of the present invention. FIG. 6c is a schematic illustration of a patch for use in a method according to an illustrative embodiment of the present invention spot welded into position.

Referring to FIG. 1a-d there is a cross sectional representation of the major steps involved in connecting first and second pipes 2,4 together via a pipe fitting 6, where the pipe fitting 6 in this illustrative embodiment comprises a coupling.

Referring to FIG. 1a, the tubular first pipe 2 has a first engagement portion 8 that comprises the end portion of the first pipe 2 that seats into a second engagement portion 10 defined by the pipe fitting 6. The first pipe 2 and pipe fitting 6 are tubular and the pipe fitting defines a socket 12 into which the first engagement portion 8 is received. The direction of engagement is indicated by arrow 14. Both first and second engagement portions 8,10 of the first pipe 2 and pipe fitting 6 respectively have a longitudinal axis, and the first pipe 2 is received into the socket along this axis.

Referring to the pipe fitting 6 in more detail, in the first illustrative embodiment this pipe fitting is a coupling designed to couple two pipes. It will however be appreciated that the coupling may alternatively be, for example, an end cap to provide a termination for the first pipe 2. Furthermore, in the event of the pipe fitting being a coupling, various embodiments are envisaged such as an elbow, bend, T-piece or cross fittings. The coupling 6 effectively comprises a sleeve defining a first socket 12 for the first pipe 2 and second socket 16 for receipt of the second pipe 4. An annular projection 18 extending inwardly from an inner surface of the coupling provides a shoulder for the first and second pipes to abut to ensure an installer knows when fully inserted to an optimal position to ensure a positive engagement and seal. A plurality of optional annular seals 20 are provided for sealing between the outer circumferential surface of the first engagement portion and the inner circumferential surface of the pipe fitting 6. The seals 20 act to guide the first engagement portion 8 into engagement and maintain appropriate alignment. Furthermore, as the first engagement portion 8 is located into the second engagement portion 10, the seals 20 act to clean the first engagement portion. In addition, when inserted, the seal 20 that is located outwardly of the weld zone prevents contaminants from entering into the pathway between the outer surface of the first engagement portion 8 and inner surface of the second engagement portion 10.

The pipe fitting 6 in the illustrative embodiment has a plurality of annular grooves 22. Such grooves can be utilised to guide a welding apparatus around the external circumference of the pipe fitting 6 thereby ensuring that the weld is perform at the appropriate location. These grooves, combined with the annular projection 18, ensure the weld is performed at both the correct location of the pipe fitting 6 and the correct location of the pipe 2.

Referring to FIG. 1b, the first engagement portion 8 is positioned into engagement with the second engagement portion 10 and the distal end of the pipe 2 is abutted against the projection 18. Referring to FIG. 1c, the welding apparatus 24 is located around the outer periphery of the pipe fitting 6 and has lugs 26 that seat into the corresponding annular grooves 22. Arrow 28 indicates the movement of the welding apparatus 24 around the external periphery of the pipe fitting 6. The welding apparatus 24 comprises a heating element 30 carried by a body 32 which is reciprocated relative to the body between a retracted and extended configuration, such that as the heating element 30 moves from a retracted to the extended configuration the heating element 30 melts and penetrates both the first engagement portion of the pipe and the second engagement portion of the pipe fitting forming a weld. In the illustrative embodiment shown, where the pipe is received into the pipe fitting, the heating element melts and penetrates through the entire wall thickness of the second engagement portion 10 and partially through the wall thickness of the first engagement portion 8. As the welding apparatus progresses around the periphery of the pipe fitting 6, a circumferential weld 36 as best shown in FIG. 1d is formed. This blocks any potential leak path between the first and second engagement portions 8,10. As the embodiment as shown in FIG. 1 presents a pipe fitting comprising a coupling, the welding process is repeated with a second pipe 4 thereby connecting two pipes 2,4 blocking any leak path. The process is fast and effective.

It will be appreciated that for some applications the welding apparatus 24 may be positioned into the bore defined by the pipes 2,4 and welding performed from inside the bore. As such, the weld is performed radially outwardly and the heating element 30 must penetrate through the entire wall thickness of the pipe and partially through the wall thickness of the pipe fitting 6.

Referring to FIG. 2a and b, in this embodiment the pipe fitting 6 is presented which is inserted into first and second pipes meaning that no change in the external diameter of the first and second pipe is required at the joint. This is useful in some applications such as for example when an elongate pipe must be inserted inside a pre-existing metal pipe for extending the lifespan of a pre-existing metal pipe.

FIG. 2 a and b show schematic cross-sectional representations of a first and second pipes 2,4 welded together via a pipe fitting 6. In these embodiments the annular projection 18 projects outwardly from the external diameter of the pipe fitting 6. The pipe fitting 6 comprises a second engagement portion 10 for engaging with a corresponding first engagement portion 8 of the pipe 2. In this embodiment the second engagement portion 10 is received into a distal end of the pipe 2 until the distal end abuts the annular projection 18. The second engagement portion 10 has a profile where the radial thickness increases away from a leading end 40 to provide a hydrodynamic profile. In the schematic illustration of FIG. 2a, the circumferential weld 36 is schematically represented as having been performed from internal the pipe fitting 6 and in FIG. 2b from external the pipe fitting 6 and pipe 2. The weld apparatus will be positioned depending on the accessibility of the joint and surface in which it is desirable to have no weld surface visible. Utilising either methodology a secure joint can readily be achieved and assuming that the weld apparatus is rotated through the entire circumference of either the inside of the pipe fitting or outside of the pipe the flow pathway between the pipe fitting and pipe itself is sealed.

Referring to FIG. 3, there is a schematic cross-sectional representation of a typical coupling where polymeric pipes have been welded using for example electrofusion welding utilising an electrofusion coupling 6 which carries a resistive wire which upon passing current therethrough causes heating and melting of the surrounding material thereby effecting a weld. As described above however there are often failures with such a coupling. A typical leak path 50 is shown from the internal bore of the pipes 2,4, between the respective engagement portions of pipe and pipe fitting, then out at the end of the point of overlap between the pipe and pipe fitting. There is a significant problem with these type of pipe joints, and as such pipes can be buried in highly inaccessible locations significant time and effort is spent in digging them up for repair.

Referring now to FIG. 4a, there is a schematic cross-sectional representation of a repair according to an illustrative embodiment of an aspect of the present invention. In the illustrative embodiment the repair is to an electrofusion coupling 6, however it will be appreciated that leaks in pipes generally or leaks in other pipe fittings can be repaired by this method. The method utilises the deployment of a weldable repair insert 52 in the form of a sleeve having an outer surface shaped and dimensioned to generally correspond to the inner shape and dimensions of the repair zone. The weldable repair insert 52 is transported to the required location by a remotely operated device. An overlap region is then defined between the between the weldable repair insert and the pipe (first and second pipes 2,4 in the illustrative embodiment). A welding apparatus 24 comprising a heating element 30 carried by a body 32 is then deployed to the overlap region through the pipe conduit by a remotely operable carrier vehicle. The weldable repair insert and the pipe are then welded in the overlap region by reciprocating the heating element 30 relative to the body 32 between a retracted and extended configuration, such that as the heating element 30 moves from a retracted to the extended configuration the heating element melts and penetrates both the weldable repair insert 52 and the pipe forming a weld. It will be appreciated that both temporary and more permanent repairs may be completed depending on the specific requirements. For example, a spot weld 36 may be performed at one or more locations providing a temporary repair, whilst alternatively the welding apparatus 24 may be moved circumferentially whilst reciprocating the heating element at a reciprocation frequency to provide a complete circumferential weld 36 and therefore seal the potential leak path. The weldable repair insert 52 and pipe comprise polymeric materials. It will be understood that the welding apparatus 24 may instead be positioned external of the pipe. This means that the weld zone is through the coupling (if present), the pipe and then partially through the insert 52.

Referring to FIG. 4b, there is a schematic representation of an insert 52 for use in performing the method according to an illustrative embodiment. The insert may comprise one or more projections 55 extending radially outwardly from the outer surface of the insert. This results in the wall thickness of the insert being thickened in a radial direction. The one or more projections 55 may be the same material as the insert or may be a material different to the insert. In the embodiment shown, the projections extend around the entire circumference of the insert, however it will be appreciated that there may be multiple individual projections disposed around the circumference of the insert. The one or more projections provide a function of being a sacrificial material for reducing resistance to deployment of the insert into the pipe, and for centrally aligning the insert in the bore of the pipe. Additionally, the projection(s) may provide extra material at the weld zone. One or more seals may also be located on an outwardly facing surface of the insert and may extend circumferentially around the insert.

Referring to FIG. 4c, an insert 52 having projections 55 is shown in isolation but in a welded configuration for clarity purposes with the welding apparatus 24 still positioned in the internal bore of the insert. The weld 36 extends through the insert wall, through the projection 55 and then partially into the wall of the pipe (not shown in FIG. 4c).

Referring now to FIG. 5, presented is a cross sectional representation of a pipe for repair, and a complete weldable repair insert 52 in the form of a split ring. Arrow 54 represents a potential leak pathway that may result from microcracks in the pipe wall. Alternatively, it may be necessary to provide reinforcement for the pipe. The ring comprises overlapping first and second distal ends 56a, 56b. By providing overlapping ends the ring readily radially compresses thereby reducing in diameter. This allows introduction into a pipe by a suitable positioning arrangement capable of effecting radial compression, following which when located at the desired location allows release and associated expansion to secure in communication with the internal wall surface of the pipe. The ring is then held by frictional engagement. Welding can then be completed by a welding apparatus (not shown in FIG. 5) either from internally of the ring whereby the weld is through the thickness of the ring and into the wall of the pipe, or alternatively from externally of the pipe where the weld is through the entire thickness of the pipe wall and partially through the thickness of the ring.

Referring now to FIGS. 6a-c a further embodiment of the present invention is presented whereby a repair is completed using a patch 60. FIG. 6a shows a cross section of a pipe 2 with a T-piece that must be sealed. Accordingly, the repair is performed by sealing the opening 62 to the T-piece using the patch 60. In FIG. 6a the side profile of the patch 60 is visible, and in FIG. 6b the patch 60 is shown welded to the internal surface of the pipe wall. The patch is flexible, and therefore conforms to the shape of the pipe wall. The patch is positioned into the bore of the pipe and positioned against the pipe wall. This step may be performed by the welding apparatus, and therefore the patch is carried into position by the welding apparatus. The patch 60 is then welded to the pipe wall from inside the bore, where the weld may be a continuous weld as shown in FIG. 6b or may be a plurality of spot welds as shown by the patch 60 in FIG. 6c. In FIG. 6b the heating element 30 is reciprocated to form an elongate weld to form a loop around the entire patch 60, and therefore provides a seal for example around the T-piece as shown in FIG. 6a.

Aspects of the present invention have been described by way of example only and it will be appreciated to the skilled addressee that modifications and variations may be made without departing from the scope of protection afforded by the appended claims.

1. A method of welding a first pipe to a pipe fitting, the method comprising:
providing a pipe having a pipe engagement portion;
providing a pipe fitting having a pipe fitting engagement portion for engagement with the pipe engagement portion;
engaging the pipe and pipe fitting engagement portions to provide an overlap region between the pipe engagement portion and the pipe fitting engagement portion; and
providing a welding apparatus comprising a heating element carried by a body, and welding at least a portion of the pipe engagement portion and the pipe fitting engagement portion by reciprocating the heating element relative to the body between a retracted configuration and an extended configuration in the overlap region, such that, as the heating element moves from the retracted configuration to the extended configuration, the heating element melts and penetrates the pipe engagement portion and pipe fitting engagement portion forming a weld.

2. The method according to claim 1, wherein the pipe comprises a first pipe having a first pipe engagement portion and there is further provided a second pipe having a second pipe engagement portion, where the pipe fitting comprises a first pipe fitting engagement portion and a second pipe fitting engagement portion, and the method further comprises the step of engaging the second pipe engagement portion and the second pipe fitting engagement portion to provide a second overlap region, and welding at least a portion of the second pipe engagement portion and the second pipe fitting engagement portion by reciprocating the heating element relative to the body between a the retracted configuration and an extended configuration in the second overlap region, such that, as the heating element moves from the retracted configuration to the extended configuration, the heating element melts and penetrates the second pipe engagement portion and the second pipe fitting engagement portion forming a second weld.

3. The method according to claim 1, wherein the method is a polymeric pipe welding method.

4. The method according to claim 1, wherein the pipe engagement portion and the pipe fitting engagement portion comprise a longitudinal axis, where the heating element reciprocates in an axis substantially perpendicular to the longitudinal axis of the pipe engagement portion and the pipe fitting engagement portion.

5. The method according to claim 1, wherein the heating element reciprocates relative to the body as the body is moved along the overlap region to form an elongate weld.

6. The method according to claim 5, wherein the body is moved circumferentially around the overlap region such that the elongate weld extends circumferentially around the overlap region.

7. The method according to claim 1, wherein the pipe has a pipe wall having a pipe wall thickness and the pipe fitting has a pipe fitting wall having a pipe fitting wall thickness and reciprocating the heating element such that the heating element melts and penetrates through an entirety of the pipe wall thickness or an entirety of the pipe fitting wall thickness and partially through another of the pipe wall thickness or the pipe fitting wall thickness.

8. The method according to claim 1, wherein the welding apparatus is guided around the overlap region by one or more annular guide formations in the pipe and/or the pipe fitting.

9. A method of repairing a pipe, the method comprising deploying a weldable repair insert into a repair zone in a bore of a pipe to provide an overlap region between the weldable repair insert and the pipe; and
providing a welding apparatus comprising a heating element carried by a body and welding the weldable repair insert and the pipe in the overlap region by reciprocating the heating element relative to the body between a retracted configuration and an extended configuration, such that, as the heating element moves from the retracted configuration to the extended configuration, the heating element melts and penetrates the weldable repair insert and the pipe forming a weld.

10. The method according to claim 9, wherein the heating element reciprocates relative to the body as the body is moved along the overlap region to form an elongate weld.

11. The method according to claim 10, wherein the body is moved circumferentially around the overlap region such that the elongate weld extends circumferentially around the overlap region.

12. The method according to claim 9, wherein the pipe has a pipe wall having a pipe wall thickness and the weldable repair insert has a weldable insert wall having a weldable insert wall thickness and reciprocating the heating element such that the heating element melts and penetrates through an entirety of the pipe wall thickness or an entirety of the weldable insert wall thickness and partially through another of the pipe wall thickness or the weldable insert wall thickness.

13. The method according to claim 9, wherein the weldable repair insert comprises a whole or partial ring, and the method comprises the steps of radially compressing the whole or partial ring and locating into the bore at the repair zone and subsequently releasing the radial compression in the repair zone such that the whole or partial ring expands to be held in a weld zone by a friction fit between the whole or partial ring and the pipe.

14. The method according to claim 9, further comprising performing a welding step from inside the bore of the pipe.

15. The method according to claim 14, further comprising carrying the welding apparatus to the overlap region by a remotely operable carrier vehicle.

16. The method according to claim 9, further comprising operating the welding apparatus from a remote location.

17. The method according to claim 9, wherein the weldable repair insert comprises a patch.
